(19) United States
(12) Patent Application Publication
(10) Pub. No.: US 2005/0161289 A1
(43) Pub. Date: Jul. 28, 2005

(54) Animal powered electricity generator

(76) Inventor: Maximo Gomez-Nacer, West New York, NJ (US)

Correspondence Address: MAXIMO GOMEZ, P.O. Box 296, WEST NEW YORK, NJ, 07093-0296, US

(21) Appl. No.: 10/808,558

(22) Filed: Mar. 24, 2004

Related U.S. Application Data
(60) Provisional application No. 60/538,408, filed on Jan. 22, 2004.

(51) Int. Cl. F03G 5/00

(52) U.S. Cl. 185/15

(57) ABSTRACT

A system and method for generating electricity by means of increasing the velocity of an animal on a mechanical device directly or indirectly attached to the hoof or other part of the limbs of the animal to use the force of its muscle contraction and the force produced by its gravity to make spin multiplying wheels in communication to an electricity generator. According to a preferred embodiment, there may be a frame; four points of support to the ground, a suspension system for the animal, at least one foot support that exerts leverage action on a link to translate the stepping motion of the animal into angular momentum where at least one big gear is connected to at least one smaller gear where different numbers of gears may be used to increase the revolutions on the drive shaft of the electricity generator.

### BACKGROUND OF THE INVENTION

The present invention generally relates to generation of electricity using biological energy. Prior art within this realm are vast thought industry and it Includes the use of minerals, gas, water, wind, solar and even tide energy, in order to generate electricity.

Biological forces however have been used in a limited way in the generation of energy. By means of the present writing I am going to describe the mode of operation, the function and the effects of this device that uses the animal power (meaning true horse power, for example) in order to generate electricity.

Since ancient times, human has been known to utilize animals to assist us in multiples shores specifically as a transport and agricultural aid. Horses, for instance, has been used to power machinery at least as early as the 16^{th} century. Stationary sweeps are illustrated and described by Ramelli in 1588, and in Germany, by Agricola in 1556. In the early 19^{th} century most horsepowers, for example, were still stationary and fitted with simple low speed gearing. By the 1830's, in America, both portable sweeps and railway treadmills had evolved to power groundhog threshers and many forms of gearing were developed to increase the speed of both sweeps and treadmills as required by the evolving threshing machines. On the other hand Single shaft horse-drawn vehicle where the shaft is attached to the horse by a neck collar has been used for even a longer time. Improvement to this included a harness articulated to a small saddle about a vertical axis of articulation, a shaft mounted on a small saddle in a semi-rigid fashion and a single shaft mounted on a traction cradle connected to a harness. U.S. Pat. No. 5,410,863 discloses a harness device for a horse drawn vehicle.

Well-known examples of this within the art may include horse-drawn carriages, racing sulkies, and hitch carts. U.S. Pat. No. 5,076,041 issue Proust, discloses a typical hitch for a single shaft horse-drawn vehicle. As discussed in the '041 patent, single shaft horse-drawn vehicles place a good deal of strain on the horse, and may cause sore and rubbing. Further, such technology does not address the process if utilizing the force of the muscle contraction of animals like horses and the force produced by the animal's gravity to make rotate a spinning mechanism by means of a device directly or indirectly connected to the hoof or other part of the limbs of the animal, to generate energy that can be used in the production of very cost efficient electricity by means of a generator or similar device and in turn can be stored in batteries for further use.

Also related to the present invention are mechanisms primarily used to modify the motive power horse (and other animals) in order to gain some mechanical advantage. U.S. Pat. No. 4,078,829 issue to Davis discloses a racing sulky. Key to '829 patent, and much of the prior art, is the idea of altering, in some form, the forward motion of the horse to generate a more useful means of power, including the use of gear trains and pulley systems to alter the mechanical advantage of the system. However, such systems are only capable of going as fast as the horse will carry them.

Despite the extent of known prior art in this field, a demand exists in areas for the mechanism, which can enhance the efficiency and productivity of animal driven rotating mechanism that can be used to generate electricity. The new concept is to use the natural movement of flexion and extension of the legs of the animal and the force produced by the animal's gravity to move a spinning mechanism that multiply the animal's force by means of a device directly or indirectly connected to the hoof of the animal or connected to any other part of the limbs of the animal. This new device will have as many uses as the electricity itself and it is intended to be used anywhere electricity is needed, specifically in rural areas where the generation of electricity is limited or non-existent.

### SUMMARY OF THE INVENTION

The present invention provides a system and method for producing electricity using the biological energy of the muscles of animals like horses by means of a device that optimizes the efficiency of the animal using its gravity and draft force as well as the natural movements of flexion and extension of animals to spin a rotational device that is directly connected to its hoof or other part of the animal's limbs and exerts an increasing leverage force on a rotator system which in turn is connected to one (or more) electricity generator by means of different multiplying gears. It is envisioned that in most instances the animal will require training but the principle is based on the fact that animals are trainable. Hamsters can move a wheel and they enjoy doing that. Horses are capable of doing things that hamsters cannot do. According to one embodiment of the present invention, an animal powered generator of electricity is disclosed comprising; a frame configured to have at least one track with adjustable angle of inclination. The frame is to be supported on the ground by at least three points. The track provides support to small trolleys and support to the animal to a greater extend. The trolleys are moved by the action of the hoof or any other portion of the limb of the animal while providing a guide to its movements. The trolleys have small ball bearing wheels above and bellow (optional) the tracks in order to avoid deviation from the desired path. The trolleys serve as a guide to carry the foot supports that receive the hoofs of the animal in its walking position. The foot support in turn serves as attachment for a foot link(s) that exert leverage action on a rotational device. The foot support, or limb support, or hoof support, or horse boots or horseshoe or any other device attached to the limb of the animal helps to restrain and attach the animal to the machine. They are removable devices in such a way that by means of using them we can directly or indirectly attach the animal to the machine to make the machine rotate using its movements. This is superior to a treadmill where we use only fifty percent of the force of the movement of the animal but it is envisioned that a platform where the animal runs “free” similar to a treadmill could be used as well in the present embodiment for the specific purpose of generation of electricity without departing from the present invention. It is also envisioned the used of multiple attachment devices that could link any part of the limbs of the animal to the machine without departing from the present invention. On the other hand each foot link has a first end and a second end; at least one coupling system is in rotational communication with at least one said foot link to translate the stepping motion of a horse into angular momentum; According to the present embodiment of the current invention I envision two coupling mechanism (one for each pair of limbs) and at least twelve foot links (three foot links for each limb) in rotational communication to the two rotator mechanisms. By means of the rotator mechanism that is attached to the limbs of the animal we can convert the parabolic movement of a complete stride of the animal into 360 degrees rotation and we can increase the draft force of the animal by means of the leverage action of the links attached to a part of the limb of the animal where said link pass thru a pivotal axis which acts as fulcrum for the lever while at the same time another limb links favors the spinning action of the weight of the animal in the rotator mechanism. The present embodiment will have one electricity generators or similar device connected to the two rotational mechanism, by means of a chain and multiplying gears in order to increase the amount of spinning per seconds or revolutions per minute of the generator or similar to obtain the desired voltage, for the desired application. According to the embodiment of the present invention we can easily produce at least 50 revolutions per second using a simple first gear fifty times the size of the second gear having in mind the animal can complete a full stride of one second. (The force is greater than this using the combined effect of the four limbs working together obviously). If we use a 4-pole d-c generator with a simplex-lap armature winding having 1ooo ooo lines of magnetic flux per pole, with 440 armature face conductors, we can generate a voltage of 220 volts. It is envisioned the use of several multiplying gears in the present invention in order to achieve higher revolutions and voltage. It is also envisioned the used of multiple horses in order to produce increased force on the main axis of the generator of electricity or similar device. It is envisioned that technically it is not difficult to achieve at least one megawatt of electricity. This is an example in order to illustrate how would be the function of the potential use of the present invention that because of its production cost and weight could be used practically anywhere we can have an animal like an echinus moving.

The foot links, which consist of connections between the leg links or limb links and the rotator mechanism, might be connected to any portion of the limb of the animal. The better placed for the attachment of the link is on the hoof of the animal but they may be attached to any portion of the limb. The spinning of the rotating mechanism is favored by means of levers, which have their fulcrum at a pivot axis so the first end of each foot link travels in a closed path relative to a pivot axis, the coupling system (or crankshaft like mechanism) being in rotational communication with at least one said foot link to translate the stepping motion of a horse into angular momentum to the pivot axis. There may also be a second and a third limb link in direct communication to the rotator mechanism in order to obtain a full 360 degrees rotation of the mechanism and in order to maximize the use of the weight of the animal exerting rotational pressure over the said crankshaft like mechanism by means of links supporting springs that compensate for the variable force of contraction used by the animal in every stride. It is envisioned that more foot links may be added to the rotational mechanism using a folk like split of the short arm of the lever after the fulcrum and using other wheels to support the main rotational mechanism at different angulations. On the other hand different multiplying gears are connected to the rotational mechanism in order to optimize the desired production of electric energy in the electric generator or similar device.

### BRIEF DESCRIPTION OF THE DRAWINGS

FIG. 1 is a front view of a Animal Powered Electricity Generator, according to an embodiment of the present invention

FIG. 2 is a rear view of a preferred embodiment;

FIG. 3 is a side view of the points of restrain of the animal, and the foot links (200, 184, 159)

FIG. 4 is a detailed side view of only the first link of the coupling system according to one embodiment of the invention.

FIG. 5 depicts a frontal view of the Animal Powered Electricity Generator according to the present invention,

FIGS. 6A, B, C, and D depicts a lateral view of the rotational mechanism or crankshaft like mechanism.

FIG. 7A Depicts a lateral, frontal and superior view of the rotational mechanism during the point B of the animal movement

FIG. 8A-J depicts a horseshoe and attachment device as used in accordance with the present invention.

FIG. 9 depicts a side view of the progression of movements according to the embodiment of the current invention;

FIG. 10A depicts a superior and lateral view of the restraining mechanism conformed by an adjustable frame.

FIG. 11 depicts a method according to the present invention;

FIG. 12 depicts the rail tracks that support part of the weight of the animal to the frame. FIG. 12B represent a frontal view of the trolleys that run along the rails.

FIGS. 13A, 13B, 13C, 13D depicts a lateral view of the coupling mechanism at points A, B, C, D.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention discloses an Animal Powered Electricity Generator. This invention may be used for any application that the generation of electricity can allow us. There may be at least two foot support, in rotational communication with the wheels of the apparatus. It should be understood that many different embodiments are envisioned, including the addition of several generators or animals.

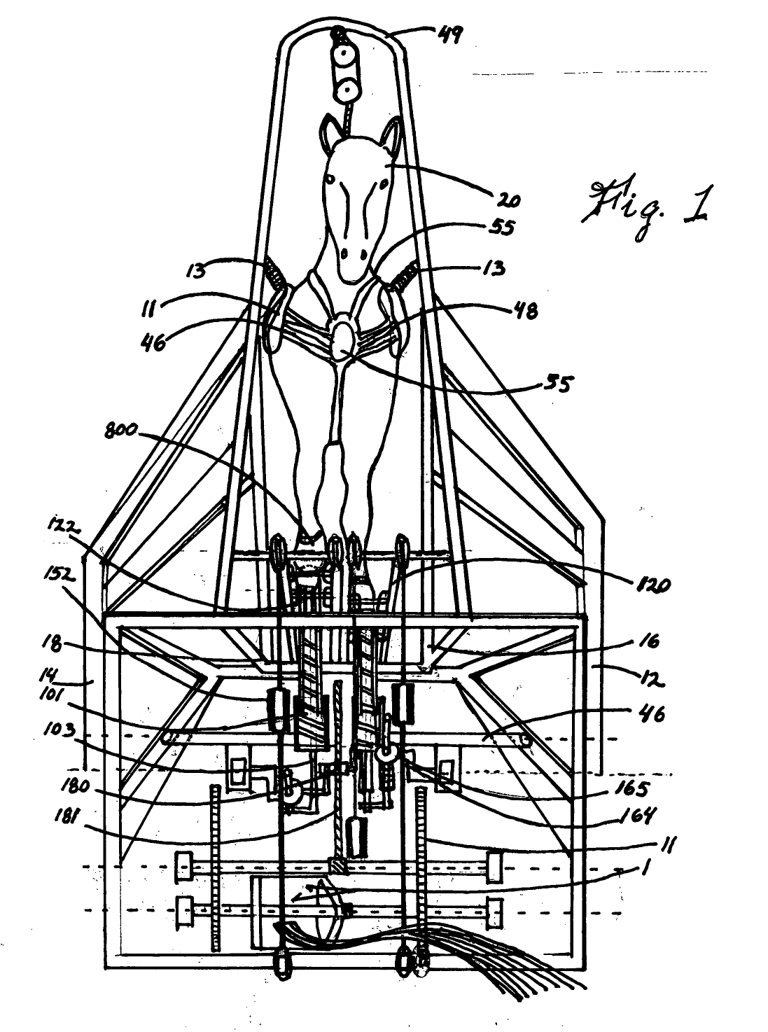

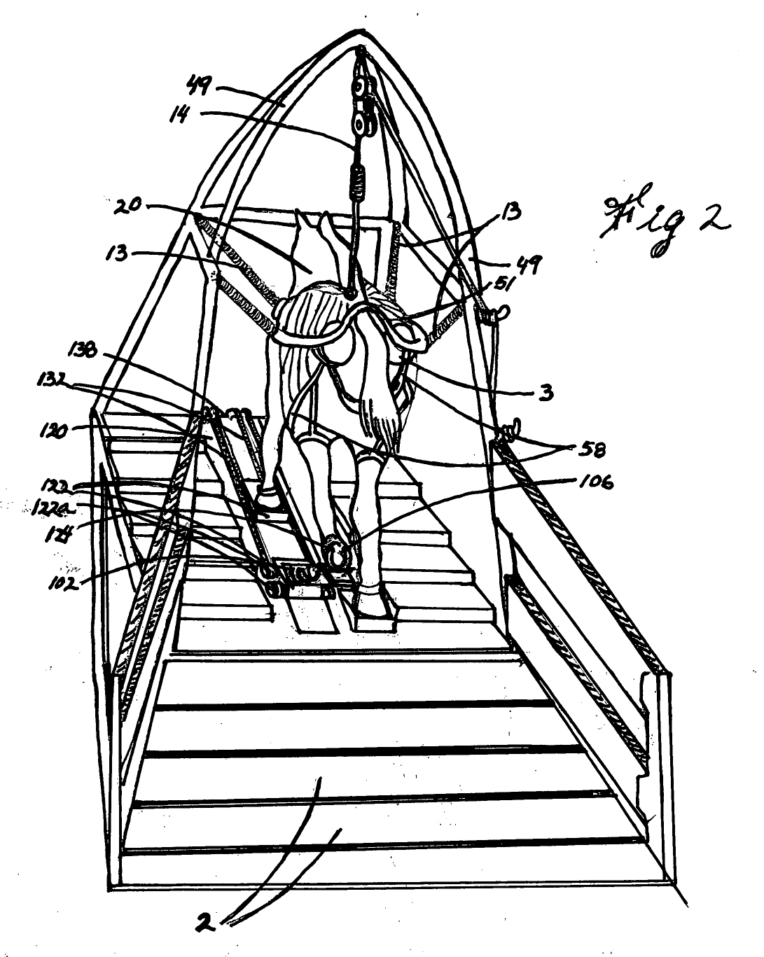

FIGS. 1-2 depict a Animal Powered Electricity Generator to be supported on the ground by at least three points, or frame supports (12-14, 16, 18) It should be understood that more than one animal might be used as well as more than three frame supports or legs for the frame. The frame should have as many supports or legs as necessary to warrant the safety of the animal. There are four-foot links (40,42) coupled to a rotator mechanism (44). The foot support may also merely act to support the horse by means of the trolleys that are supported by the rail track (120) that is a part of the frame (the trolleys are represented in FIG. 2 and FIG. 3, and FIG. 12B (122). There should be at least four foot supports for receiving the hoofs of a horse 20 in walking or standing position. It should be understood that the term coupled is used to describe that the first ends of each foot link are connected to the rotating mechanism. There may be a number of gears and translation bars coupling the first end to the wheel so as to rotationally translate and multiply the movement of the horse to the rotating mechanism that in turn is connected to a generator by means of multiplying gears.

FIG. 3 represents a side view of the points of restrain of the animal 51, 55, 57, 59, using an internal frame 10 and different girths 58 and cushioned restraints in order to place the animal in the ideal location inside the mechanism. The picture depicts the upward slope created by rails in the frame with four small trolleys 122 moving along the rail track of the frame 120. The animal is attached to the main frame of the device (10) by means of springs (13) attached to the internal frame or animal frame 11, which is adjusted to fit very close to the body of the animal in order to avoid rubbing of the skin (See also FIG. 10A). The limbs of the animal are attached to the variable angulations adjustable track 120, which is a part of the main frame, supported on the ground. The variable slope of the track is very important because by raising it we can increase the force produced by the animal. The hoofs (or other parts of the limb of the animal) are connected to a small trolley 122 that runs along the variable angulations adjustable track 120. Every small trolley has four bearing ball wheels that stand on the rail track and two or four wheels bellow the rail track in order to facilitate its smooth movement while it makes not possible for the animal to separate its limb from the desired track and frame. It is envisioned that trolleys may have different number of wheels which function is to minimize the friction along the track. The hoof of the animal or any other part of the limb are supported on an small platform 109 that is attached to the trolley by a hinge that opens on its anterior portion 108 in order to mimic the natural final quick off or contraction of the hoof at the point when the limb is reaching its most posterior position by means of the contraction of the posterior extension muscles of the limbs. The figure depicts the arm links in relation to the rotating mechanism. The first arm link is composed by bar like expansible levers 101 that contain several expansion springs 130 inside expansible tubes of decreasing diameter 130, mainly one outer tube 101 and an inner tube 102, separated by ball bearing 104 in order to facilitate its contraction and extension. More than two tubes of decreasing diameters may be used. The levers are connected to a pivotal axis 46 that has the function of a fulcrum. The second portion of the lever is one or more than one small arm(s) 113 that produces increased force on the rotational mechanism 44 by means of semi rigid flexible first links 184, and second link, 200. There is a third link 159 that connects directly the inferior portion of the limb of the animal. This third link 159 may be attached to the base of the hoof of the animal or foot support-like in the present figure—by means of an axis that allows pendulum motion in the same direction of the movement of the animal. The third link moves from there to the rotational mechanism to be attached at a rotational screw passing thru a grove inside it in such a way that by means of springs it contributed to add the force of the weight of the animal on the rotational mechanism while still producing some cushion effect to the animal's stride.

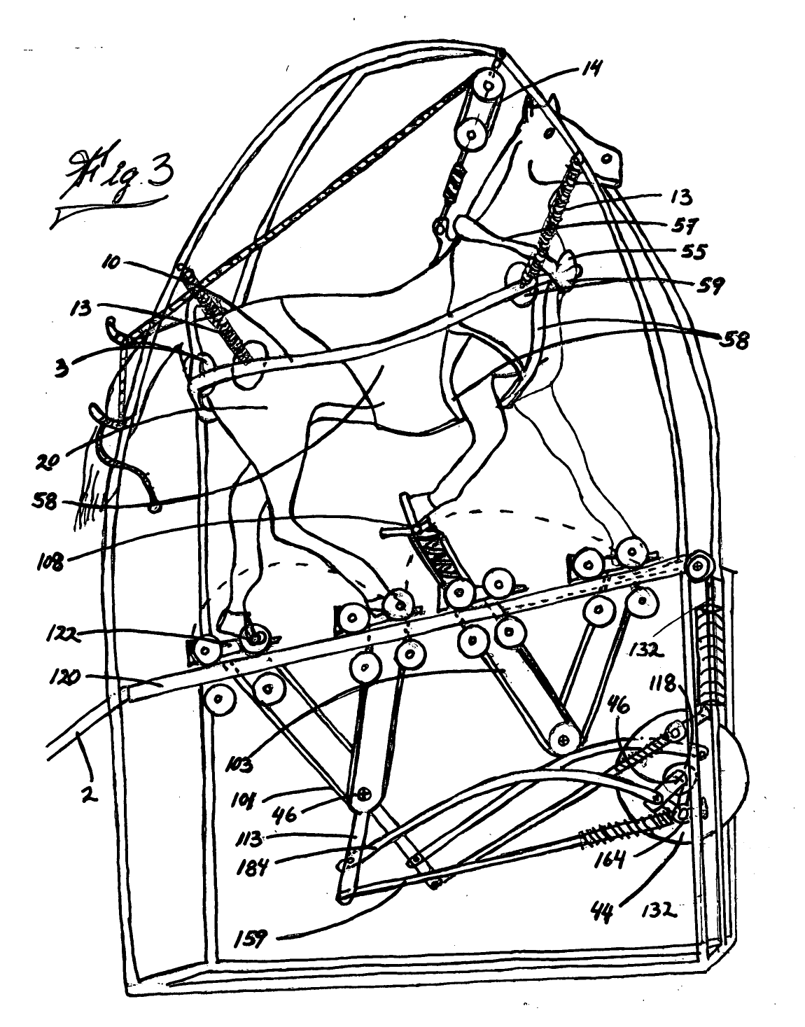

FIG. 4 is a detailed side view of only the first link of the coupling system according to one embodiment of the invention. Please note the chain (115) that can connect the big gear of the mechanism (11) to the smaller gear (9). The smaller gear may be the site for the attachment of the main shaft of the generator or similar device (1), (not shown) because it is the place where we obtain multiplying velocity. This is the simplest possible relationship of gears but it is envisioned adding several multiplying gears according to the desired application of the generator. It is clear that we can change the angulations and places of attachment of the links obtaining the same effect without departing from the present invention. It is also understood that we can keep the mechanism simple using only one link (like in this picture) and we do not need a chain or belt (which offers higher resistance to the mechanism than a direct contact between the cogs of the gears because they have greater surface of contact) The picture depicts also a mechanism for changing gears (119) which might be used to change the voltage production by changing the amount of revolutions per minute, or might be use to help the animal in the beginning of the process, where there is more resistance in the machine. Please, note that we have added a high weight wheel (900) to the same axis of the big wheel in order to facilitate the rotation of the generator once the animal is moving at a steady pace. The high weight wheel might be also attached to the main axis of the generator (1), not shown. The chain might be necessary to connect the movement of the four legs working together on a rotational mechanism in order to concentrate all the force on only one generator or similar (1).

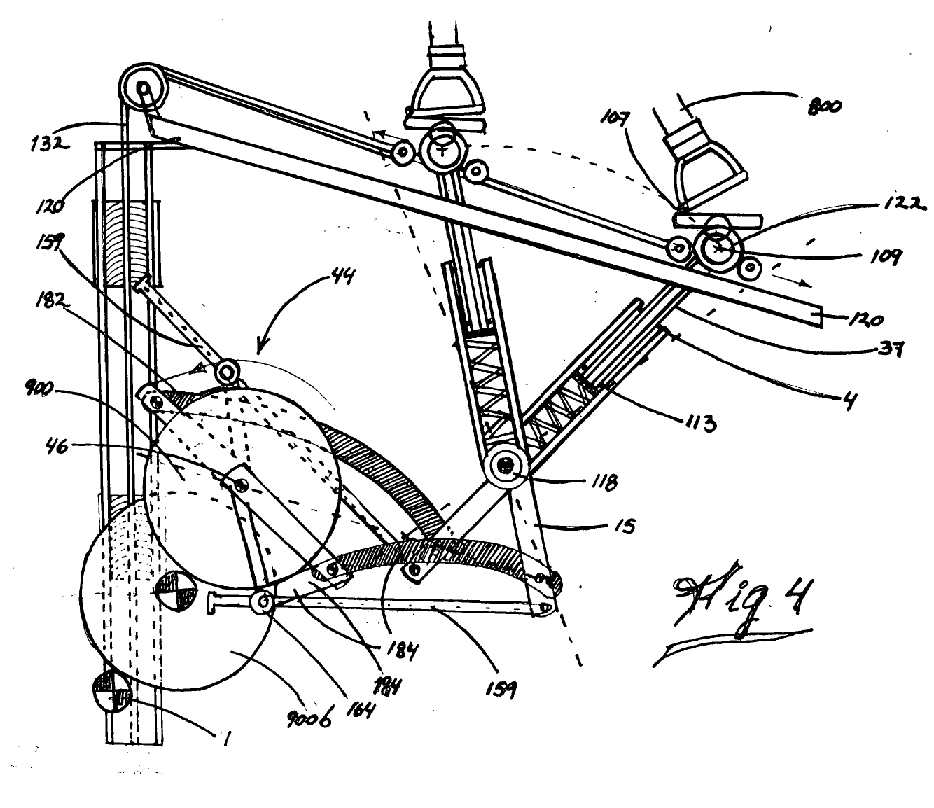

FIG. 5 Corresponds to a frontal view of the Animal Powered Electricity Generator according to the present invention, (without depicting the animal) and where we can notice the frontal representation of the trolleys running along a track. The “big” gear of the coupling mechanism (11) is in direct communication to the small gear (9) of the generator or similar device (1). There is a “heavy” wheel to assist the generator to its rotation (900) once the animal gets its steady pace.

FIGS. 6A, B, C, and D depicts a lateral view of the rotational mechanism or crankshaft like mechanism. Please note that there are three links for every foot, including the rotational screw that serves as attachment point for the third link.(164) If we consider the first link (184) to be at cero degrees, then the second link would be at attached at approximately 180 degrees (200) and the third link would be between 180 and 270 degrees. The picture depicts a convenient 205 degrees attachment point for the third link.

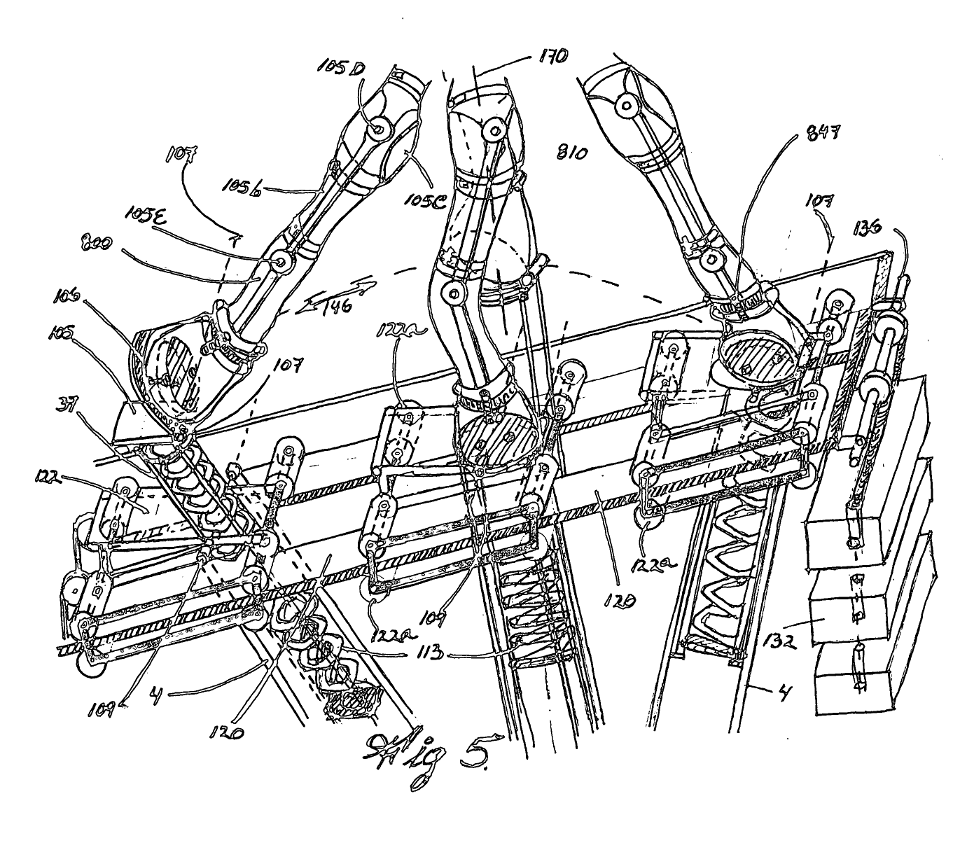

FIG. 7A Depicts a lateral, frontal and superior view of the rotational mechanism during the point B of the animal movement, (which is when the leg on the most anterior point just in contact with the trolley on the rail track). FIG. 7B depicts a superior view at the same moment in time, and FIG. 7C depicts a frontal view of the crankshaft like mechanism at the same moment in time. As it was explained on the FIG. 6 the first link is moved by the action of the connecting short arm after the pivotal axis 166. The same level moves the second foot link on a different attachment point. The third link, which is directly attached to the base of the hoof of the animal, moves in the same direction of the parabolic movement of every stride of the animal and uses the advantage of the weight of the animal. In this figure you can see the progression of movements to achieve 360 degrees rotational movement as described above by following the sequence A, B, C, and D. Furthermore the rotational mechanism of the crankshaft like mechanism has a big gear in direct communication with a second smaller gear, (example, fifty times smaller) that produces the desired revolutions per minute on the electricity generator. We have to understand that depending on the size of the gears relative to one another, they may translate the angular momentum of one gear relative to another. It should be understood that a number of different gear types and sizes may be utilized without departing form the present invention.

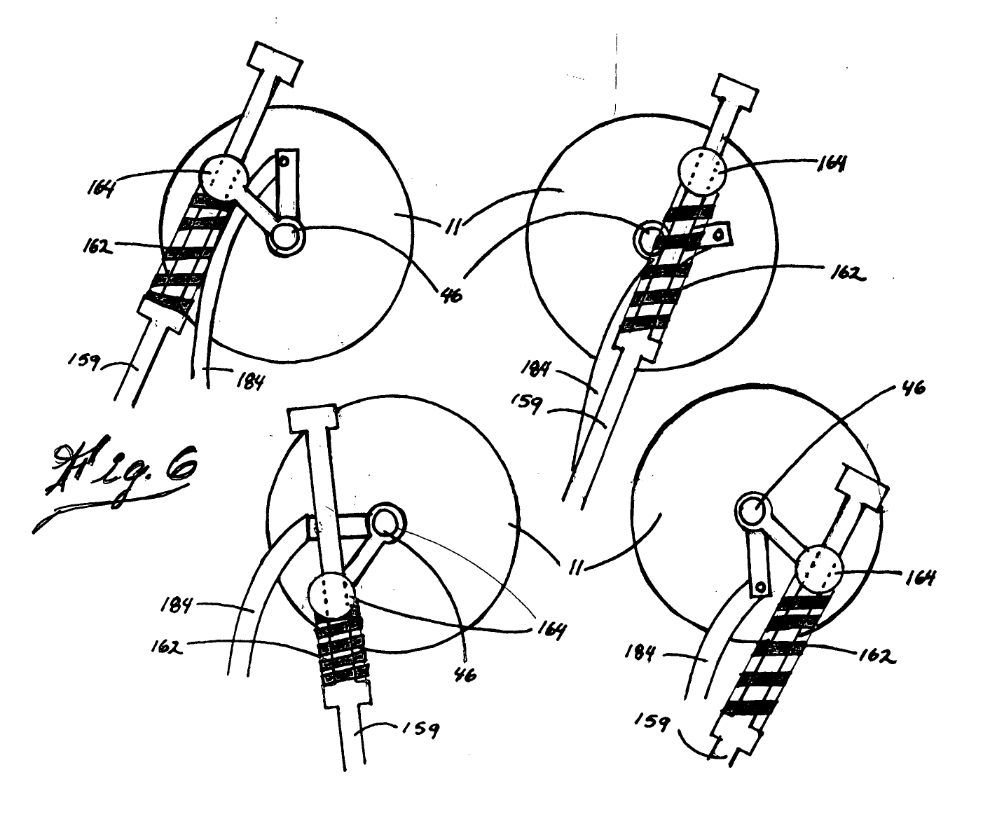

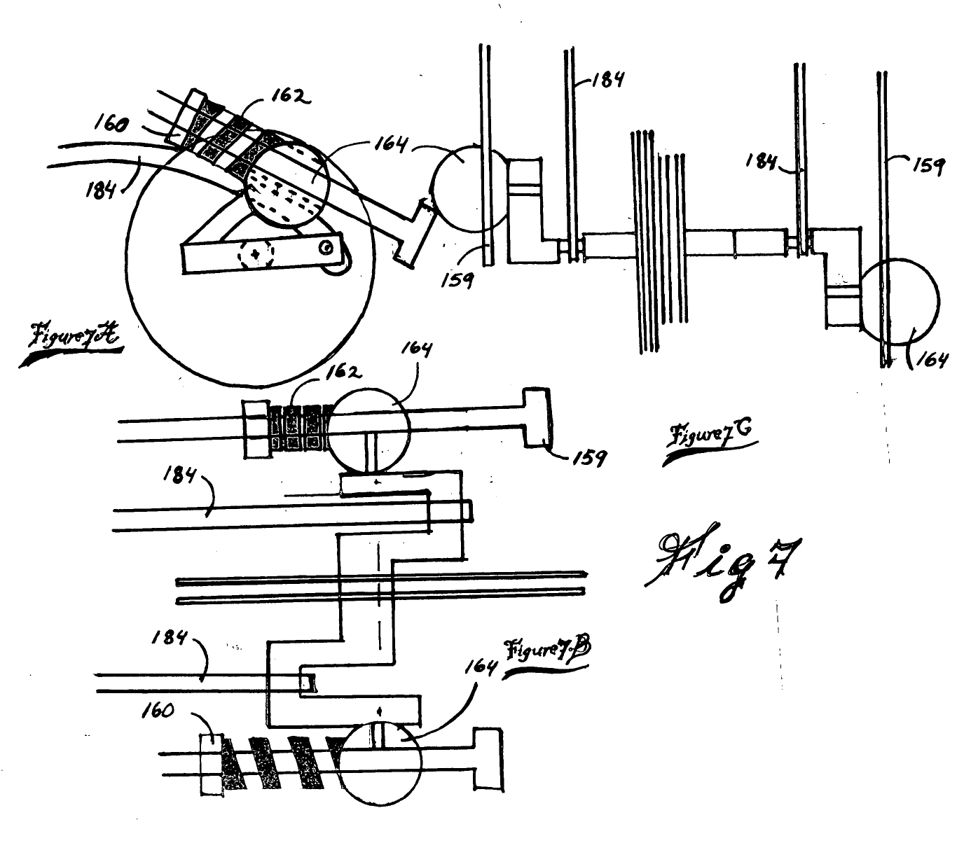

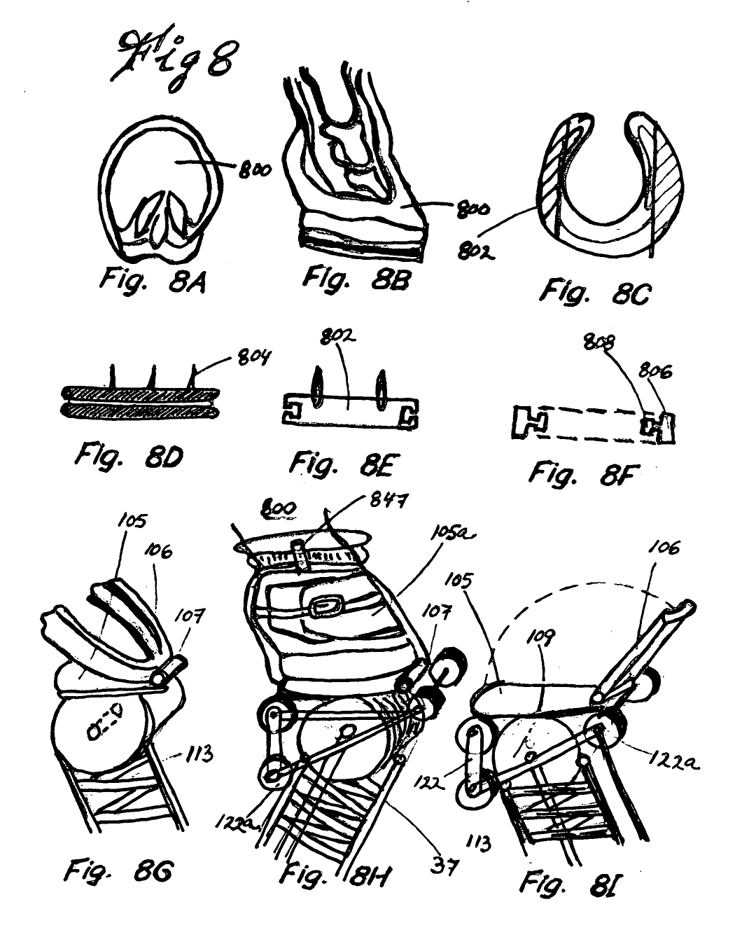

FIGS. 8A-J depicts a horseshoe as used in accordance with the present invention. The tubes that serve as attachment for the horseshoe to the coupling mechanism slide along the center portion of the trolleys (See also FIG. 12) that run along the rail tracks 120. In other words, the trolleys guide the movement of the limbs of the animal along the right track while still they allows certain degree of expansion of the limb in its movement upwards to allow a parabolic movement due to the effect of the springs 113 inside the concentric tubes 4,37. The springs facilitate the movement of the hoof out of the trolley when it reaches the lowest point of the track in a way that the summation force of all the different springs, force the limb to move forward when it reaches the lowest point of the track (vs. rather letting the animal stay there resting). At the bottom of the track 120 there is a small electric switch 121 that sends a light signal to stimulate the animal when it keeps the limb in that position for a undesired period of time.

FIGS. 8A-8I depict an embodiment of an attachment device, specifically a horseshoe for easy connection of the horses hoof to the foot support. FIGS. 8A and 8B depict a horse hoof 800. FIGS. 8C, 8D and 8E depict a bottom, side and front view of the horseshoe 802. As shown, the horseshoe is shaped to have a receiving portion 806. Referring to 8F, the receiving portion 806 receives a protrusion 808 on the inside of the upper portion 106 of the horseshoe. The term foot support as claimed, may encompass a number of different embodiments. According to the embodiment shown, the foot support is comprised of the upper portion 106, hinge 107 and bottom portion 105. FIG. 8G depict and elevational view of the horseshoe as attached to the arm 37. The bottom portion 105 of the horseshoe may be attached to the horse trolley by a axis 109. FIGS. 8H and 8I are intended to depict the range of motion. As shown, the top portion 106 and bottom portion 105 are in communication by means of a hinge 107. The top portion 106 may also be opened. When attached to the horse, the top portion 106 typically could open more than 180 degrees from the bottom portion 105. FIG. 8J depicts and elevational lateral view of the horseshoe attached to the limb of the animal. The limb of the animal is in its vertical position close to the middle of the track 120 corresponding to each limb. We achieve this by restraining of the animal in that position with the help of the restraining system (FIG. 10B). This allows to the animal the optimum parabolic movement of the limb along the track because the center of the femoral joint will have the optimum range of motion with “some space” anterior and posterior for moving the limb. It is clear that the maximum distance of any stride is a number limited by the summation of the size of the bones of the limb of the animal in its most anterior or most posterior moving. In other words that taking a simple measure of two consecutive prints of the same hoofs gives us an idea of the right size of the track of the mechanism for the limb. Then we place the animal close to the middle of it as shown on the picture. The picture shows also a number of different attachment devices to protect and attach the hoof 105a, pastern 105a, cannon 105b, and knee of the animal 105c to the foot support 105, 106. The picture also shows several lateral flexible support of the knee 105d and fetlock joint 105e in order to link all different attachment devices and to provide extra support to the joints. This supports 105d, 105e work as axels that allow easy optimum flexion and extension while limit the abrupt lateral movements of the animal that could produce dislocation of these joints. It is understood that this points do not have contact with the skin of the animal, while the supports 105a, 105b, and 105c are padded inside for the comfort of the animal. The padded supports as well as the flexible supports may all be connected together by means of a light metal or similar material support 105f which runs at both sides of the limb in order to produce a better function as attachment device on a greater surface of the limb and in order to produce a firm protection of the limb. The picture depicts the wedge shape trolley 122 with the flat surface on the top for the comfort of the animal in every stride. There are springs or strings 132 or variable number of weights 133 that pull the trolley constantly to the upper part of the track. (See also FIG. 12) There is an optional skin stimulator for air or other stimulus 134 for arousing the animal when the leg reaches the point d at the bottom of the track where it is located the switch 121 for this device.

FIG. 9 Depicts a side view of the progression of movements according to the embodiment of the current invention; note the upslope line represent the adjustable upward sloped track of the frame in order to facilitate the movement of the animal using its gravity and in order to increase the force on the animal.

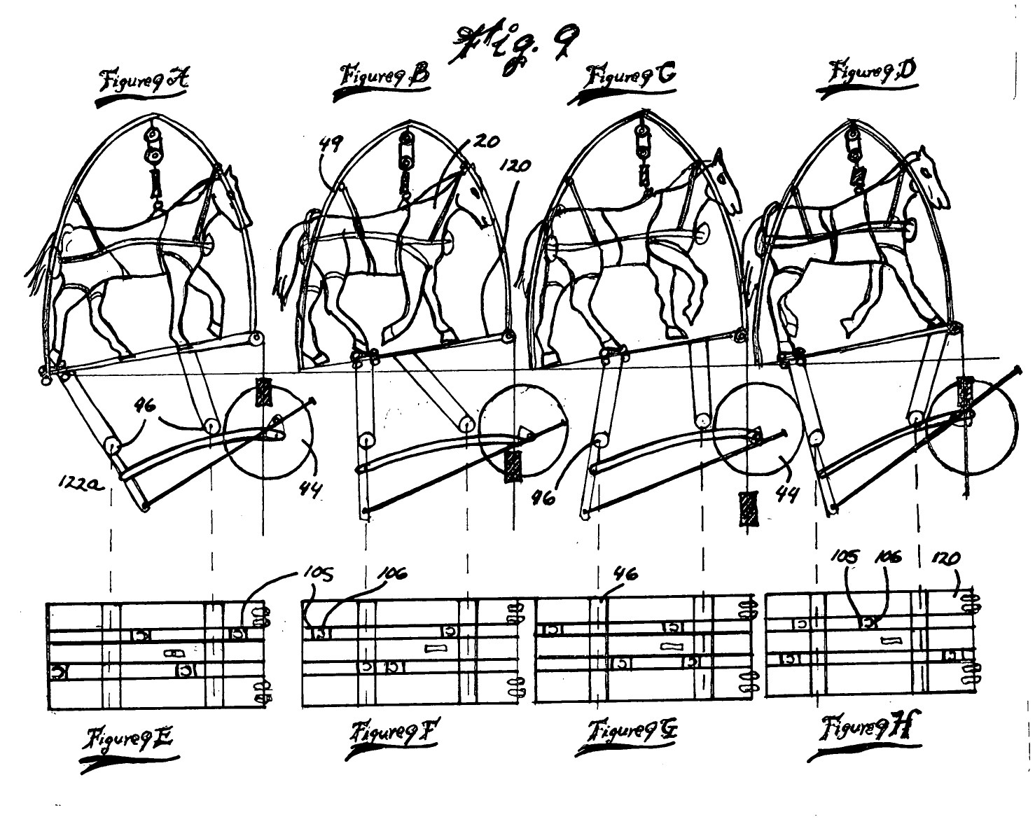

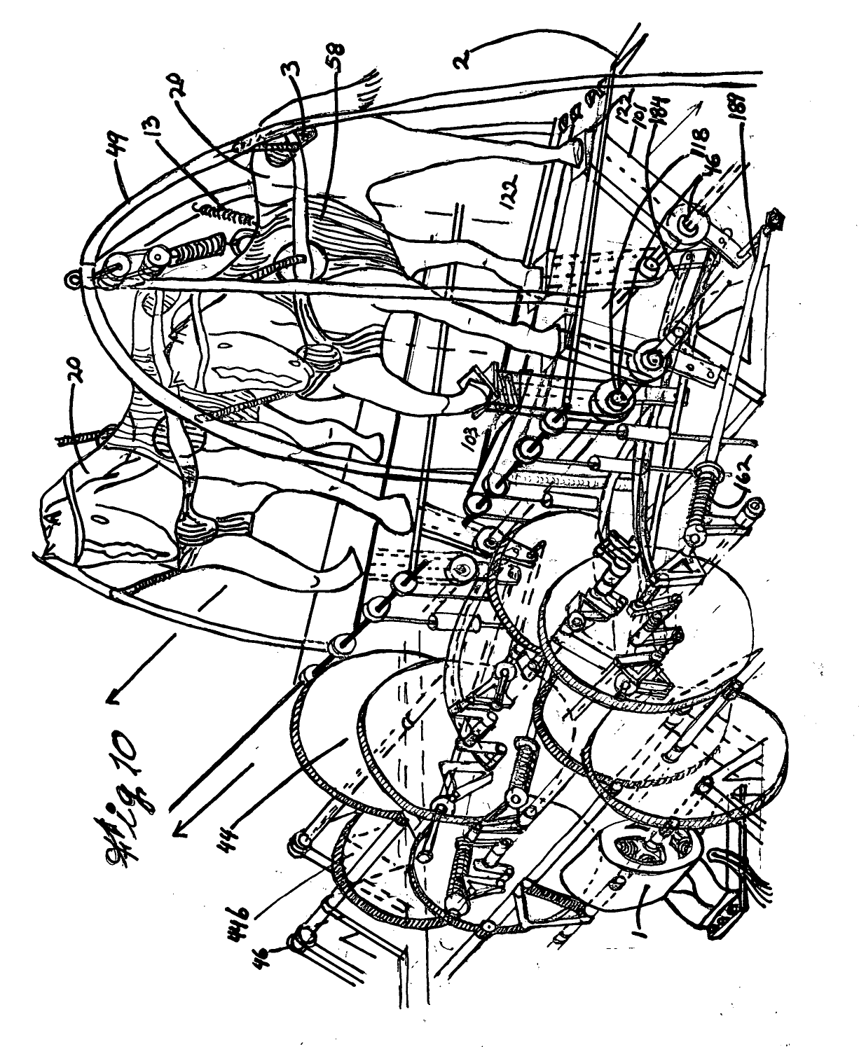

FIGS. 9a-9H depicts the motion of the horse. FIGS. 9a-9d depict the motion of the horse required to turn the wheels the first 180 degrees while by means of the present continuation; adding a second arm and a crankshaft like part will complete the 360 degrees with every single step of every leg. FIGS. 9E-9H depicts the corresponding top views of the foot supports. FIG. 9E corresponds to FIG. 9A. FIG. 9F corresponds to FIG. 9B. FIG. 9G correspond to FIG. 9C. FIG. 9H corresponds to FIG. 9D. The horse 20 may start with the front left 900 foot raised forward (See also FIG. 14, position A) and the right back 902 foot being raised. As shown in FIG. 9B, pressure may be placed on the front left 900 foot and left back 904 to start the wheels turning. The front left 900 leg is raised, the horseshoe is open in this position while attached by a hinge to the bottom portion 105 of the horseshoe which acts as the foot support. When the foot Completes the cycle after is all extended back and flexed again to the position up in the air, the rotational mechanism have turned 360 degrees. The motion is repeating with the right foot now being forward to provide an additional force to the opposite part of the crankshaft. Expansion springs are added to all the four first part of the link making them an expansible semi-rigid first links 184, and second link 200 (please see FIG. 13) in order to compensate for any difference in the timing between the right and the left part of the crankshaft during the four different gaits that the animal may have. In other words the alternating movement of the right and the left leg does not need to be completely synchronized in opposite directions order to produce forward movement on the crankshaft. Adding expansion springs to the links allows that both legs can even move in the same direction (as during the gallop) and the links will still have the flexibility to “conserve the energy” of the movement to make the crankshaft rotate forward.

FIG. 10A depicts a superior and lateral view of the restraining mechanism conformed by an adjustable frame. The adjustable frame is done of a light but resistant material 10 and it consists of several arches 11, and several tubes that can be adjusted to each other to the exact shape of the body of the animal by means of holes and screws 12 that are placed together to restrain the animal in the ideal position along the rail tracks 120. The center for the femoral joint 170 and for the humeral joint 172 is represented in order to mark the ideal location in relation to the main frame of the apparatus 110. The adjustable frame 10, is used in order to attach to it the belts 53, the girths 58, or cushions 59, 55 used to prevent the animal from scares or rubbings when it is walking while still restraining it in the right place. It has a special shirt made of a resistant cushioned material and is just below the girths 58 that holds the animal above and bellow the thorax and is used to lift the animal up when it animal is initially getting trained on the machine or to provide additional restraining. The shirt is cushioned inside and it provides an increased surface area to the girths to prevent the ribs from fracture when the animal is lift during the training or during operation. The animal is “fixed” to the main frame of the device by means of springs that allow certain movement necessary for a comfort walking movement while still preventing the animal from going out of the mechanical device. FIG. 10B depicts a lateral view of the restraining mechanism, which was also explained in part in the FIG. 3.

FIG. 11 depicts a method according to the present invention;

FIG. 12 depicts the rail tracks that support part of the weight of the animal to the frame. FIG. 12B represent a frontal view of the trolleys that run along the rails and move with every stride the first and second link of the rotator mechanism (not represented). The small trolleys function as attachment point for the horseshoes, in order to force the movement of the animal to go in one direction only thanks to the force of gravity, (as if the animal were walking uphill) or as if the animal were walking on a sloped treadmill. The advantage of this mechanism versus the treadmill used in the past is that by attaching a part of the limb of the animal directly to the coupling mechanism that I propose here, we are using almost the one hundred percent of the force generated by the muscle of the animal in every stride and we multiply it with the leverage action of the foot link while the treadmill only uses half of the energy produced by the movement of the animal (which is only when the animal stands on the surface of the treads)

FIG. 13 depicts a lateral representation of the coupling mechanism at points A, B, C, D. where we can see the representation of the three-foot link for every limb link of the animal. (The figure represented the links of the right rear leg only) FIGS. 13A, 13B, 13C, 13D, depict the relationship between every one of these arm links for the right rear leg as they move the coupling system at time a, b, c, and d, to translate the stepping motion of an animal into angular momentum. The lower portion of the figures, depict a superior view of the arm links and the coupling system. It depicts also the multiplying gearing to connect the rotational mechanism to the generator. Scale is 1:10.

It is envisioned that the same electricity generation can be used to provide a small electric stimulus applied to a portion of the body of the animal in order to make it move its legs in the same way that a rider can spur the animal In a order to make it run faster. The amount of stimulation to the animal is obviously as limited as necessary to be safe while still achieving the desired purpose of making the animal move. On the other hand any enhancement device known within the art may be utilized without departing from the present invention. For example, batteries, transformers, voltage regulators, equalizers, magnetic amplifiers, transistors, transformers, electric motors, or any other electronic device that might be used to improve the efficiency of the current invention. It is envisioned that another biological measuring devises such as heart and respiratory rate counters, Thermometer or even a blood pressure measuring device may all be added to the vehicle in order to safe guard the well being of the animal.

It should be understood, of course, that the foregoing relates to preferred embodiments of the invention and that modifications may be made without departing from the spirit and scope of the invention as set forth in the following claims.

1. The process by which humans can use the force of the muscle contraction of animals (like horses) and the force produced by the animal's gravity) in order to generate electricity by spinning a rotational mechanical device directly or indirectly attached to the hoof or other part of the limbs of the animal, or by means of moving any other matting or treads connected to multiplying gears specifically for this purpose of generation of electricity.

2. A frame (10) configured specifically for the purpose of confining a animal to produce electricity
Said frame configure to have an adjustable sloping rail tracks (FIG. 12) (120) to be supported on the ground by at least three points (FIG. 1) (14,16,18) attached to said frame (10) and access ramp (2)
Further comprising at least two points for the attachment of the animal to the apparatus (46,48) where the ideal attachment or fixing points of the frame should be located at both sides of the animal and above the animal (49) near its center of gravity in the thorax.
Further comprising at least two foot links (40,42) coupled to at least one rotational mechanism (44), wherein one foot link has a first end an second end; at least four foot supports (FIG. 8) (105, 106, 107) for receiving the hoofs of a horse (or any other part of the limb of the animal) in walking position,
Further comprising at least two small trolleys one food support located on a adjustable small platform (or wedge shaped) small trolley (122) that runs along the rail tracks (120) with the help of wheels or ball bearings above (125) and below (127)(optional) the track (120) in order to avoid displacement of said trolleys (122) out of the track (120), like for example when the animal produce vigorous movements.
Further comprising said foot supports in connection with at least two foot links for the coupling mechanism.
Further comprising a pivotal axis (FIG. 3) (46) for the connection of the foot link to the coupling mechanism is such a way that the foot link produces leverage action of the rotating mechanism because it is acting as a fulcrum.
Further comprising at least one coupling system (44) in rotational communication with at least two-said foot link (184, 200) to translate the stepping motion of a horse into angular momentum;
Further comprising expansion springs along the path of the first links in connection to the first foot or limb link in order to facilitate the movement of the leg out of the trolley when it reaches the resting position FIG. 13D (position d).
Further comprising contraction springs or strings with weights (FIG. 8J) that pass trough a guide on the upper most part of the rail tracks in order to constantly pull the leg of the animal to the above-mentioned position.
Further comprising at least one generator for electricity or an alternator and converter of electricity or similar device in order to produce it.
Further comprising batteries to store the electricity.

3. An Animal Powered Electricity Generator further comprising an limb attachment device configured specifically for the purpose of making the animal to produce electricity
Said attachment device (FIG. 3, FIGS. 8A, 8B, 8C, 8D, 8E, 8F, 8G, 8H, 8I, 8J) is designed for attaching the hoof of the animal or any other portion of the limb of the animal in a removable fashion, to said links of the rotational mechanism in order to obtain the desired effect of generation of electricity.
Further comprising a hinge (107) or similar for the anterior flexion of the hoof at the end of the stride.
Further comprising padded supports at the level of the hoof, cannon and knee of the animal as well as connecting supporting axels with metal or similar material providing connection among them in order to protect the limb and prevent the joint from dislocations when the animal is moving for the specific intention of generation of electricity.

4. An Animal Powered Electricity Generator further comprising a restrain and suspensor system (FIG. 3, FIG. 10B) designed specifically for the purpose of confining a animal to produce electricity by containing said animal (like a horse) within the above mentioned frame,
Further comprising a restrained system consisting of girths (52) supported by a inner light material (like aluminum or plastic) (11) adjustable frame around the animal
Further comprising a protective and restraining animal shirt (58) around the thorax of the animal
Further comprising restraining girths (52,53) supported by different cushions (51,55,59) or cushioned tissues to separate the skin of the animal from the hard surfaces in order to avoid scratches or any skin damage to the animal.
Further comprising holding springs for the animal's (13) that bind the animal (FIG. 3, FIG. 10B) at both sides of the main frame and might hold the animal as well from above (14) near the center of gravity of its thorax. Said Suspensor mechanism designed for the specific function of allowing the animal to perform the free desired movements of flexion and extension that are necessary for the generation of electricity while it contributes to minimal friction of the skin of the animal and avoids that the animal gets out of the mechanism

5. An Animal Powered Electricity Generator further comprising a crankshaft like coupling or rotational system specifically designed for the generation of electricity (FIG. 6, FIG. 7, FIGS. 13A, 13B, 13C, 13D (44)
Further comprising a main bigger wheel for accelerating the animal force by means of multiplying gears (FIGS. 5, 6, 7)
Further comprising an attachment place (500, 600, 164) for receiving the different foot links at different degrees of angulations in order to produce a complete 360 degrees of rotation with every single stride of the limbs of the animal.
Further comprising two foot link or limb link in communication with a foot support on one end, by means of the lever, and in communication to the rotational mechanism on the other end; where said limb links consist of semi rigid flexible bars (184, 200) with springs inside to compensate for the variable force that the animal can produce with the contraction of its muscles.
Further comprising a specific place of attachment for receiving the animal weight consisting of a rotational screw (164) with a grove inside that allows the free movement of a bar (or third link) along it (FIGS. 6A, 6B, 6C, 6D)
Further bar directly linked to the limb (or hoof) of the animal (FIG. 3, FIGS. 13A, 13B, 13C, 13D) on one end and to the rotational mechanism on its center (164)
Further comprising one proximal top (160) and a proximal spring (162) that produce pressure on the rotational mechanism (44) with the weight of the animal and in some form continues to conserve the gravity energy after the animal stands on the trolley.
Further comprising said third link with another spring (163) which is distal to its attachment point in the rotational mechanism (164) with a distal top (165) that allows the continuation of the rotational force of the springs on the mechanism at a different angulation's from the first two links (184, 200) in order to continue to facilitate the rotation at different times of the stride of the animal.
Further comprising levers which can be expansible (FIGS. 13A, 13B, 13C, 13D (101,102) by means of springs inside them (102), FIG. 4 (4, 37, 113) directly attached to the limb link on one side and attached to the first semi rigid flexible arm (FIG. 13) (184) on the other side of the pivotal axis (46) in such a way that the axis serves as a fulcrum to the movement of the leg in its backward movement producing increased rotational force on the rotational mechanism.
Further comprising a second link (200) attached at approximately the same distance from the pivotal axis (46) as the first link, but in opposite direction, to be attached at approximately 180 degrees in relation to the first link in the crankshaft like mechanism.
Further comprising an anti-reverse screw (700) (FIG. 6) in order to make gears rotate only on one direction.
Further comprising at least one big gear (FIG. 4, FIGS. 13A, 13B, 13C, 13D) (11), in direct communication with another smaller gear (9) or in indirect communication with the smaller gear by means of a chain (FIG. 4) (115) wherein said chain or gear translates motion from said gear to said main axis, of the electric generator.

6. A propulsion compensatory heavy weight wheel for the generator further comprising one heavy wheel (900) on either the same axis of the “big” gear or in the same axis of the generator in order to achieve an optimum balance of the machine and in order to facilitate the generation of electricity once the animal pace is steady.

7. A chain shift system (FIG. 4) (119) in order to facilitate the starting, which in turn causes the rotation of at least one small wheel to produce variable amount of revolutions per minute according to the desired application of the generator on an at least one electric generator or similar device (1).

8. A stimulator for the animal (3) for compressed air, electricity or other stimulus further comprising a small current battery and pump to provide electric, air or other stimulus to the animal in the skin region of the Ischium bone or any other area in order to arouse the gait of the animal when necessary.
